(19) United States
(12) Patent Application Publication
(10) Pub. No.: US 2022/0061359 A1
(43) Pub. Date: Mar. 3, 2022

(54) Method of Manufacturing a Flavoring and Sweetening Gelatin Drop for a Beverage

(71) Applicant: Thomas McDowell, Pebble Beach, CA (US)

(72) Inventor: Thomas McDowell, Pebble Beach, CA (US)

(21) Appl. No.: 17/005,173

(22) Filed: Aug. 27, 2020

(51) Int. Cl. A23L 2/60; A23L 2/56; A23L 29/281; A23L 29/212; A23L 29/10; A23L 27/00; A23L 27/30; A23P 30/10; A23P 20/10

(52) U.S. Cl. CPC A23L 2/60; A23L 2/56; A23L 29/284; A23L 29/212; A23L 29/10; A23V 2002/00; A23L 27/36; A23L 27/37; A23P 30/10; A23P 20/11; A23L 27/84

(57) ABSTRACT

A method of manufacturing a flavoring and sweetening gelatin drop for a beverage gradually sweetens and flavors a hot beverage. The method includes a first quantity of water, a quantity of gelatin, a second quantity of water, a quantity of base sweetening mixture, a quantity of emulsification mixture, a quantity of high-intensity flavoring mixture, and a first quantity of grain-based starch. The method begins by heating and mixing the quantity of gelatin into the first quantity of water. The quantity of base sweetening mixture and the second quantity form a slurry solution. The quantity of emulsification mixture is mixed into the slurry solution. The gelatin solution and the slurry solution form the final solution. The quantity of high-intensity flavoring mixture is mixed into the final solution. The final solution is deposited into the quantity of grain-based starch, and the final solution is cured for a specified time period.

### FIELD OF THE INVENTION

The present invention generally relates to manufacturing a gelatin drop. More specifically, the present invention produces a flavoring and sweetening gelatin drop for a beverage.

### BACKGROUND OF THE INVENTION

Hot beverages are a necessity for a typical day for an individual. Whether the hot beverage is a hot cup of coffee in the morning or a hot cup of tea at night, hot beverages are a staple drinking item for most individuals. Hot beverages can be customized to the liking of an individual with a variety of condiments that may include but is not limited to, citrus, berries, cinnamon, honey, lemon, mint, ginger, and so on. Adding just the right amount of each condiment to the hot beverage is important in order to maintain the overall desired taste of the beverage. However, maintaining the right concentration of flavor throughout the time an individual is drinking the beverage is much more difficult. Typically, the condiments are added prior to drinking the hot beverage and the concentration of flavor for the condiment is very strong in the beginning or does not thoroughly mix with the hot beverage for an even and balanced flavor.

It is therefore an objective of the present invention to provide a full-bodied flavor of a condiment over a period of time for a hot beverage. The present invention is a system and method of manufacturing a flavoring and sweetening gelatin drop for a beverage. The present invention features a gummy-like consistency that melts in a hot beverage in order to provide an even and full flavor for the hot beverage.

### BRIEF DESCRIPTION OF THE DRAWINGS

FIG. 1 is a schematic view for a final solution of the present invention.

FIG. 2 is a schematic view for the final solution of the present invention being cured.

FIG. 3 is a schematic view for a plurality of drops of the present invention.

FIG. 4 is a flowchart illustrating the overall process for a method of the present invention.

FIG. 5 is a flowchart illustrating the subprocess of portioning the final solution to produce the plurality of drops for a method of the present invention.

### DETAIL DESCRIPTIONS OF THE INVENTION

All illustrations of the drawings are for the purpose of describing selected versions of the present invention and are not intended to limit the scope of the present invention.

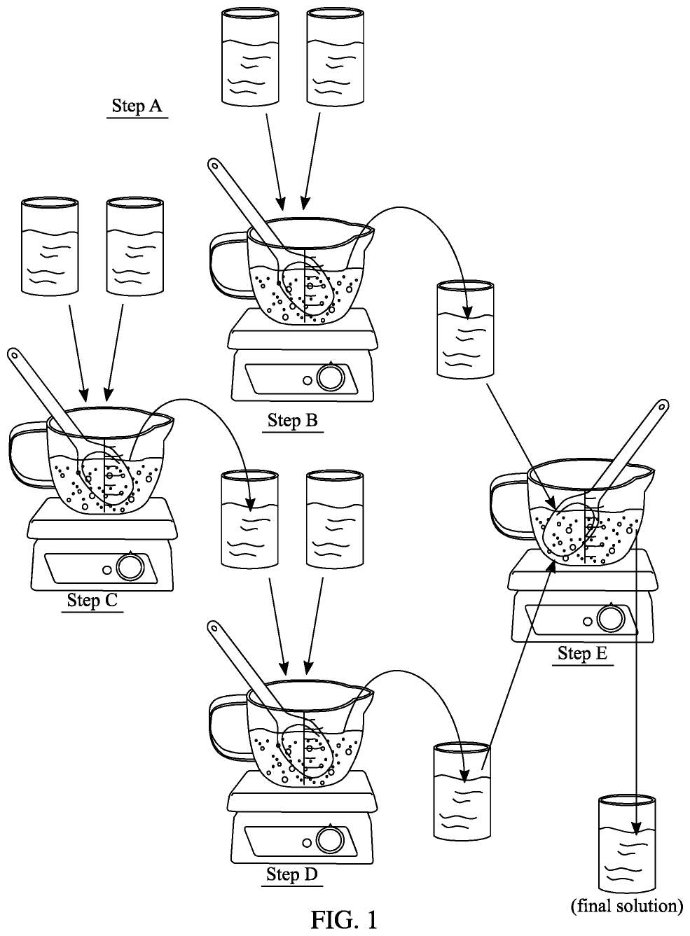

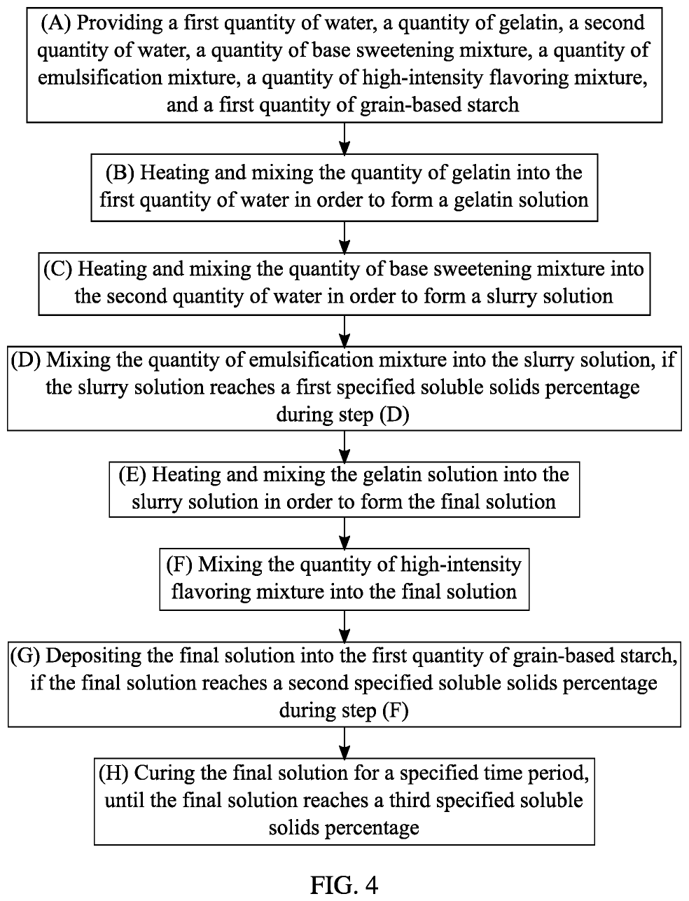

The present invention is a system and method of manufacturing a flavoring and sweetening gelatin drop for a beverage. The present invention compliments the flavor of a beverage and continuously enhances the overall flavor of the beverage as the present invention melts in a beverage. Moreover, the beverage is preferably a hot beverage so that the present invention melts and evenly mixes with the beverage. Thus, the physical system used to implement the method for the present invention includes a first quantity of water, a quantity of gelatin, a second quantity of water, a quantity of base sweetening mixture, a quantity of emulsification mixture, a quantity of high-intensity flavoring mixture, and a first quantity of grain-based starch (Step A), seen in FIG. 1 and FIG. 4. The first quantity of water and the quantity of gelatin form a gummy consistency for the present invention. In the preferred embodiment of the present invention, the quantity of gelatin is beef. The second quantity of water evenly combines the quantity of base sweetening mixture, the quantity of emulsification mixture, and the quantity of high-intensity flavoring mixture. The quantity of base sweetening mixture provides sweetness for the present invention. The quantity of emulsification mixture serves as a stabilizer for the present invention and evenly combines the quantity of base sweetening mixture and the quantity of high-intensity flavoring mixture. The quantity of high-intensity flavoring mixture provides a desired flavor for the present invention.

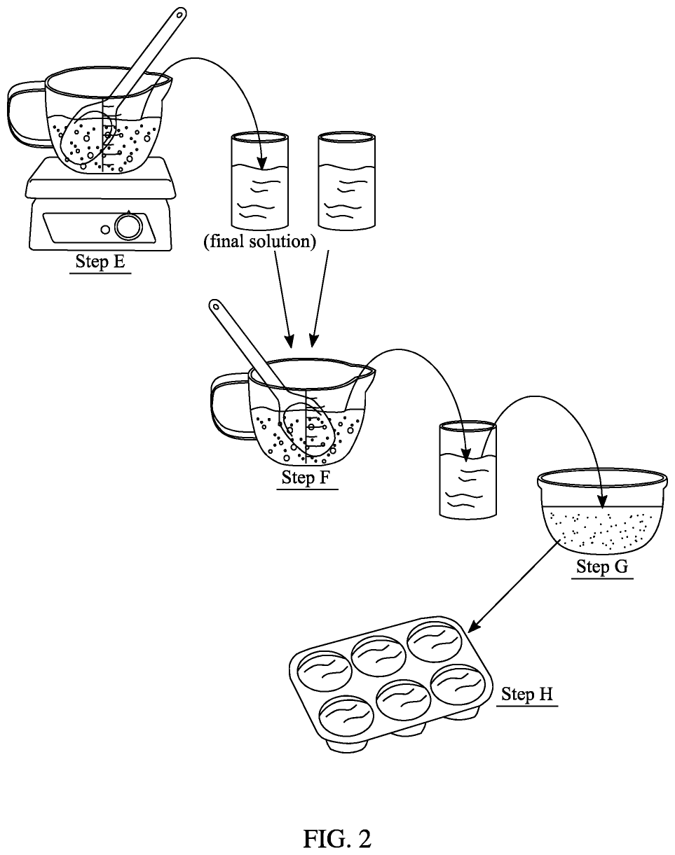

The overall process for the method of the present invention includes the following steps that are implemented with the first quantity of water, the quantity of gelatin, the second quantity of water, a quantity of base sweetening mixture, the quantity of emulsification mixture, the quantity of high-intensity flavoring mixture, and the first quantity of grain-based starch. As seen in FIG. 1 and FIG. 4, the method begins by heating and mixing the quantity of gelatin into the first quantity of water in order to form a gelatin solution (Step B). In the preferred embodiment of the present invention, the first quantity of water is heated to a temperature ranging between 185 degrees Fahrenheit and 195 degrees Fahrenheit. Once a desired temperature is reached, the first quantity of water is removed from the heat and the quantity of gelatin while constantly stirring. This prevents any lumps from developing for the gelatin solution, and consequently, the gelatin drop. Moreover, in order to maintain the consistency of the gelatin solution, the gelatin solution is heated at a preferred temperature range between 140 degrees Fahrenheit and 150 degrees Fahrenheit. The quantity of base sweetening mixture is then heated and mixed into the second quantity of water in order to form a slurry solution (Step C). The quantity of emulsification mixture is mixed into the slurry solution, if the slurry solution reaches a first specified soluble solids percentage during Step D (Step D). The first specified soluble solids percentage is approximately between 79% and 85% so that the quantity of emulsification mixture is able to effectively combine with the quantity of base sweetening mixture and the quantity of high-intensity flavoring mixture. The gelatin drop has a gummy consistency as the gelatin solution is then heated and mixed into the slurry solution in order to form the final solution (Step E). In order to produce a full flavored gelatin drop, the quantity of high-intensity flavoring mixture is mixed into the final solution (Step F), seen in FIG. 2 and FIG. 4. The final solution is deposited into the first quantity of grain-based starch, if the final solution reaches a second specified soluble solids percentage during Step F (Step G). This allows the first quantity of grain-based starch to effectively dry the final solution into the gelatin drop. Moreover, the second specified soluble solids percentage is approximately between 75% and 80%. The final solution is then cured for a specified time period, until the final solution reaches a third specified soluble solids percentage (Step H) and executed at normal temperature and pressure (NTP), to form a gummy consistency for the gelatin drop. The specified time period is preferably approximately 24 hours, and the third specified soluble solids percentage is approximately between 77% and 82%. The specified time period allows the final solution to solidify into a desired shape, and the first quantity of grain-based starch to prevent the gelatin drop from being sticky around the exterior. In reference to the aforementioned compositional proportions, the term “approximately” preferably means within an error range of up to ±0.5%.

In order to achieve a desired gummy consistency, the first quantity of water is approximately 20.07% by weight (wt.) of the final solution, and the quantity of gelatin is approximately between 6% wt. and 10% wt. of the final solution. In order for the quantity of base sweetening mixture to thoroughly mix with the quantity of emulsification mixture, and the quantity of high-intensity flavoring mixture, the second quantity of water is approximately between 2% wt. and 5% wt. of the final solution. In reference to the aforementioned compositional proportions, the term “approximately” preferably means within an error range of up to ±0.5 wt. %.

The quantity of base sweetening mixture includes at least one compositional constituent selected from a group consisting of a quantity of caloric sweetening powder, a quantity of bulking agent, and combinations thereof. The intensity of the sweetness of the quantity of base sweetening mixture is defined by the quantity of caloric sweetening powder, and the quantity of bulking agent thickens the quantity of base sweetening mixture. The quantity of caloric sweetening powder is preferably allulose powder and is approximately between 22% wt. and 27% wt. of the final solution. The quantity of bulking agent is preferably allulose syrup and is approximately between 22% wt. and 27% wt. of the final solution. In reference to the aforementioned compositional proportions, the term “approximately” preferably means within an error range of up to ±0.5%.

In order for the quantity of base sweetening mixture and the quantity of high-intensity flavoring mixture to evenly combine, the quantity of emulsification mixture includes at least one compositional constituent selected from a group consisting of a second quantity of grain-based starch, a first quantity of high-intensity sweetening powder, a second quantity of high-intensity sweetening powder, a quantity of flavor-masking agent, and combinations thereof. The second quantity of grain-based starch is a gelling agent for the quantity of emulsification mixture. The first quantity of high-intensity sweetening powder and the second quantity of high-intensity sweetening powder balances out the overall sweetness of the present invention with the quantity of emulsification mixture. The quantity of flavor-masking agent preferably masks bitter flavors of the quantity of high-intensity flavoring mixture. The second quantity of grain-based starch is preferably potato starch and is approximately between 0.5% wt. and 1.5% of the final solution. The first quantity high-intensity sweetening powder is preferably Monk fruit and is approximately between 1% wt. and 2% wt. of the final solution. In various embodiments of the preset invention the quantity of high-intensity sweetening powder may also be sucralose. The second quantity of high-intensity sweetener is preferably Stevia and is approximately between 1% wt. and 4% wt. of the final solution. The quantity of flavor-masking agent is preferably Licorice root extract and is approximately between 0.5% wt. and 1.0% wt. of the final solution. In reference to the aforementioned compositional proportions, the term “approximately” preferably means within an error range of up to ±0.5 wt. %.

The present invention provides a specific flavor for each flavoring and sweetening gelatin drop as the high-intensity flavoring blend mixture includes at least one compositional constituent selected from a group consisting of a quantity of glyceride-based emulsifier, a quantity of natural flavoring, a quantity of natural coloring, and combinations thereof. The quantity of glyceride-based emulsifier evenly blends the quantity of natural flavoring and the quantity of natural coloring with the quantity of base sweetening mixture and the quantity of emulsification mixture. The quantity of natural flavoring defines the flavor for the present invention, and the quantity of natural coloring defines the color of the present invention. The quantity of glyceride-based emulsifier is approximately between 0.5% wt. and 1.0% wt. of the final solution. The quantity of natural flavoring is approximately between 10% wt. and 20% wt. of the final solution, and the quantity of natural coloring is approximately between 0.1% wt. and 0.5% of the final solution. In reference to the aforementioned compositional proportions, the term “approximately” preferably means within an error range of up to ±0.5 wt. %.

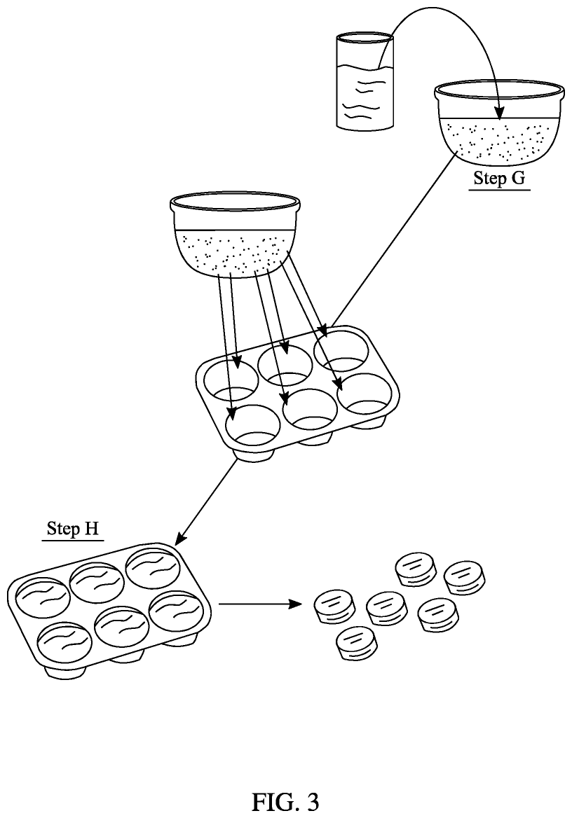

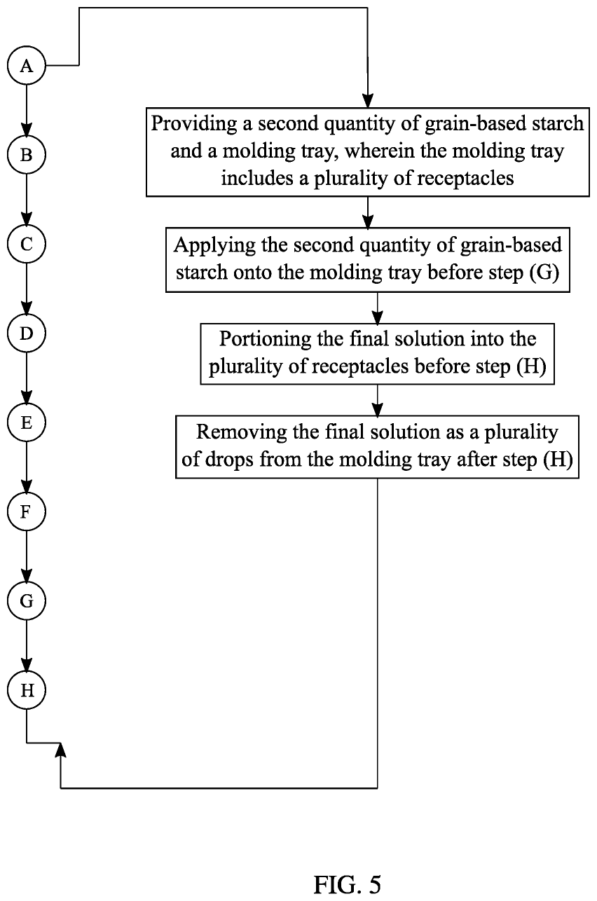

Each flavoring and sweetening gelatin drop is shaped as a second quantity of grain-based starch and a molding tray is provided, seen in FIG. 2, FIG. 3, and FIG. 5. Moreover, the molding tray includes a plurality of receptacles. The second quantity of grain-based starch facilitates the drying of the final solution. The molding tray contains each flavoring and sweetening gelatin drop, and each receptacle serves as a mold for each flavoring and sweetening gelatin drop so that an overall desired shape is achieved after curing the final solution. The desired shape of the preferred embodiment the present invention is a bee-shape as to represent the sweetness of each flavoring and sweetening gelatin drop. The second quantity of grain-based starch is applied onto the molding tray before Step G so that the final solution is dried while curing within the plurality of receptacles. Each flavoring and sweetening gelatin drop is molded with each of the plurality of receptacles as the final solution is portioned into the plurality of receptacles before Step H. The final solution is removed as a plurality of drops from the molding tray after Step H, and the present invention is ready to be added to a beverage, preferably a hot beverage.

In a first embodiment of the present invention, a quantity of oil is provided so that each of the flavoring and sweetening gelatin drops do not stick with each other. More specifically, the plurality of drops is coated with the quantity of oil. In a second embodiment of the present invention, a quantity of dry finishing blend is provided, which also prevents each of the flavoring and sweetening drops from sticking with each other. Likewise, the plurality of drops is coated with the quantity of dry finishing blend. The quantity of dry finishing blend includes at least one compositional constituent selected from a group consisting of a second quantity of grain-based starch, a quantity of caloric sweetening powder, a quantity of flavor-dependent acid, and combinations thereof. The second quantity of grain-based starch is preferably potato starch. The second quantity of grain-based starch of the quantity of dry finishing blend further prevents the plurality of drops from sticking. The quantity of caloric sweetening powder further enhances the overall and final flavor of each drop after curing. The quantity of flavor-dependent acid further preserves the plurality of drops. The quantity of caloric sweetening powder may be, but is not limited to, a quantity of polyol, allulose powder, allulose syrup, sucrose syrup, sugar-free polyol, and grain-based syrup. The quantity of flavoring-dependent acid is preferably buffered lactic acid but may also be citric acid in various embodiments of the present invention.

Although the invention has been explained in relation to its preferred embodiment, it is to be understood that many other possible modifications and variations can be made without departing from the spirit and scope of the invention as hereinafter claimed.

What is claimed is:

1. A method of manufacturing a flavoring and sweetening gelatin drop for a beverage, the method comprises the steps:
(A) providing a first quantity of water, a quantity of gelatin, a second quantity of water, a quantity of base sweetening mixture, a quantity of emulsification mixture, a quantity of high-intensity flavoring mixture, and a first quantity of grain-based starch;
(B) heating and mixing the quantity of gelatin into the first quantity of water in order to form a gelatin solution;
(C) heating and mixing the quantity of base sweetening mixture into the second quantity of water in order to form a slurry solution;
(D) mixing the quantity of emulsification mixture into the slurry solution, if the slurry solution reaches a first specified soluble solids percentage during step (D);
(E) heating and mixing the gelatin solution into the slurry solution in order to form the final solution;
(F) mixing the quantity of high-intensity flavoring mixture into the final solution;
(G) depositing the final solution into the first quantity of grain-based starch, if the final solution reaches a second specified soluble solids percentage during step (F); and,
(H) curing the final solution for a specified time period, until the final solution reaches a third specified soluble solids percentage.

2. The method of manufacturing a flavoring and sweetening gelatin drop for a beverage, the method as claimed in claim 1, wherein the first quantity of water is approximately 20.07% by weight (wt.) of the final solution.

3. The method of manufacturing a flavoring and sweetening gelatin drop for a beverage, the method as claimed in claim 1, wherein the quantity of gelatin is approximately between 6% wt. and 10% wt. of the final solution.

4. The method of manufacturing a flavoring and sweetening gelatin drop for a beverage, the method as claimed in claim 1, wherein the second quantity of water is approximately between 2% wt. and 5% wt. of the final solution.

5. The method of manufacturing a flavoring and sweetening gelatin drop for a beverage, the method as claimed in claim 1, wherein the quantity of base sweetening mixture includes at least one compositional constituent selected from a group consisting of: a quantity of caloric sweetening powder, a quantity of bulking agent, and combinations thereof.

6. The method of manufacturing a flavoring and sweetening gelatin drop for a beverage, the method as claimed in claim 5, wherein the quantity of caloric sweetening powder is approximately between 22% wt. and 27% wt. of the final solution, and wherein the quantity of bulking agent is approximately between 22% wt. and 27% wt. of the final solution.

7. The method of manufacturing a flavoring and sweetening gelatin drop for a beverage, the method as claimed in claim 1, wherein the emulsification mixture includes at least one compositional constituent selected from a group consisting of: a second quantity of grain-based starch, a first quantity of high-intensity sweetening powder, a second quantity of high-intensity sweetening powder, a quantity of flavor-masking agent, and combinations thereof.

8. The method of manufacturing a flavoring and sweetening gelatin drop for a beverage, the method as claimed in claim 7, wherein the second quantity of grain-based starch is approximately between 0.5% wt. and 1.5% wt. of the final solution, and wherein the quantity of a first quantity of high-intensity sweetening powder is approximately between 1% wt. and 2% wt. of the final solution, and wherein the second quantity of high-intensity sweetener is approximately between 1% wt. and 4% wt. of the final solution, and wherein the quantity of flavor-masking agent is approximately between 0.5% wt. and 1.0% wt. of the final solution.

9. The method of manufacturing a flavoring and sweetening gelatin drop for a beverage, the method as claimed in claim 1, wherein the high-intensity flavoring blend mixture includes at least one compositional constituent selected from a group consisting of: a quantity of glyceride-based emulsifier, a quantity of natural flavoring, a quantity of natural coloring, and combinations thereof.

10. The method of manufacturing a flavoring and sweetening gelatin drop for a beverage, the method as claimed in claim 9, wherein the quantity of glyceride-based emulsifier is approximately between 0.5% wt. and 1.0% wt. of the final solution, and wherein the quantity of natural flavoring is approximately between 10% wt. and 20% wt. of the final solution, and wherein the quantity of natural coloring is approximately between 0.1% wt. and 0.5% wt. of the final solution.

11. The method of manufacturing a flavoring and sweetening gelatin drop for a beverage, the method as claimed in claim 1, wherein the first specified soluble solids percentage is approximately between 79% and 85%.

12. The method of manufacturing a flavoring and sweetening gelatin drop for a beverage, the method as claimed in claim 1, wherein the second specified soluble solids percentage is approximately between 75% and 80%.

13. The method of manufacturing a flavoring and sweetening gelatin drop for a beverage, the method as claimed in claim 1, wherein the third specified soluble solids percentage is approximately between 77% and 82%.

14. The method of manufacturing a flavoring and sweetening gelatin drop for a beverage, the method as claimed in claim 1 comprises the steps of:
providing a second quantity of grain-based starch and a molding tray, wherein the molding tray includes a plurality of receptacles;
applying the second quantity of grain-based starch onto the molding tray before step (G);
portioning the final solution into the plurality of receptacles before step (H); and,
removing the final solution as a plurality of drops from the molding tray after step (H).

15. The method of manufacturing a flavoring and sweetening gelatin drop for a beverage, the method as claimed in claim 14 comprises the steps of:
providing a quantity of oil; and,
coating the plurality of drops with the quantity of oil.

16. The method of manufacturing a flavoring and sweetening gelatin drop for a beverage, the method as claimed in claim 14 comprises the steps of:
providing a quantity of dry finishing blend; and,
coating the plurality of drops with the quantity of dry finishing blend;

17. The method of manufacturing a flavoring and sweetening gelatin drop for a beverage, the method as claimed in claim 16, wherein the quantity of dry finishing blend includes at least one compositional constituent selected from a group consisting of: a second quantity of grain-based starch, a quantity of caloric sweetening powder, a quantity of flavor-dependent acid, and combinations thereof.

18. The method of manufacturing a flavoring and sweetening gelatin drop for a beverage, the method as claimed in claim 1, wherein step (H) is executed at normal temperature and pressure (NTP), and wherein the specified time period is approximately 24 hours.
